(19) United States
(12) Patent Application Publication
(10) Pub. No.: US 2009/0148575 A1
(43) Pub. Date: Jun. 11, 2009

(54) PACKAGING MATERIAL COMPRISING A COATING WITH MICROCAPSULES

(75) Inventors: Gabriele Lang-Wittkowski, Mannheim (DE); Peter Schlichting, Mannheim (DE); Ekkehard Jahns, Weinheim (DE); Norbert Heidinger, Hassloch (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/719,624

(22) PCT Filed: Nov. 15, 2005
(86) PCT No.: PCT/EP05/12235

§ 371 Date: May 17, 2007

(30) Foreign Application Priority Data
Nov. 17, 2004 (EP) 04027284.1

(51) Int. Cl. B32B 27/10; B32B 5/16; B05D 5/06; B65D 81/38

(52) U.S. Cl. 426/392; 428/211.1; 428/327; 427/288; 428/338

(57) ABSTRACT

The present invention relates to a packaging material in the form of a composite comprising at least one paper or cardboard support applied atop which there are at least one paper coating slip layer, if appropriate a print layer, if appropriate one or more thermoplastic layers and if appropriate one or more further layers, wherein at least one of the applied layers comprises microencapsulated latent heat storage material and the capsule wall of the microencapsulated latent heat storage material is constructed from

| | |
|---|---|
| 10% to 100% | of one or more C₁-C₂₄-alkyl esters of acrylic |
| by weight | acid and/or methacrylic acid (monomers I), |
| 0% to 80% | of a difunctional or polyfunctional monomer |
| by weight | (monomers II) which is insoluble or sparingly |
| | soluble in water, and |
| 0% to 90% | of other monomers (monomer III), |
| by weight | |

based in each case on the total weight of the monomers, to a process for producing it, and to its use for packaging foodstuffs.

The present invention relates to a packaging material in the form of a composite comprising at least one paper or cardboard support applied atop which there are at least one paper coating slip layer, if appropriate a print layer, if appropriate one or more thermoplastic layers and if appropriate one or more further layers, to a process for producing it, and to its use for packaging foodstuffs. It further relates to a thermoplastic layer, a printing ink, and a paper coating slip for use in accordance with the invention.

For transporting temperature-sensitive products it is usual to use packaging materials which have good insulating properties, such as Styropor® (manufacturer: BASF Aktiengesellschaft), Neopor® (manufacturer: BASF Aktiengesellschaft) or expanded polypropylene. The insulation derives from the poor thermal conduction of these materials. A drawback, however, is the high volume of these insulating materials. Within the packaging industry it is often important to transport or store as much product as possible per unit volume and not to generate transport costs or storage costs for bulky packs. Particularly in the foodstuffs sector, with product which tends to be low in price, bulky packs are uneconomic.

Conversely, foodstuffs in particular are often very sensitive in respect of any interruption in their cooling chain. In order to have a compensating effect on any such temperature discontinuities, there have in the past been attempts to integrate latent heat storage material into the packaging. The functioning of latent heat stores derives from the transformation enthalpy which occurs during solid/liquid phase transition, and which signifies absorption of energy or release of energy to the surrounding system. They can therefore be used to maintain constant temperature within a defined temperature range.

This principle has been utilized with the use of microcapsules having a capsule wall composed of a highly crosslinked methacrylic ester polymer and a latent heat storage core in coating materials for paper (basis weight 40 g/m²) for thermal printing processes, as described in EP-A-1 029 018.

Further, JP 2001 357250 describes building applications using cardboard with a microencapsulated latent heat storage material as flooring, wall, and ceiling material. The microcapsules, based on urea-formaldehyde resin and also melamine-formaldehyde resin, are mixed in with the paper stock in the course of cardboard manufacture. Microcapsules based on melamine-formaldehyde or urea-formaldehyde, however, are undesirable on account of the possibility of formaldehyde emissions.

WO-A-0292911 teaches a paper or paperboard composition comprising wet-laid short fibers and microencapsulated latent heat storage materials, and the use of the papers for shoe soles or packs.

WO-A-03002424 teaches a paper-based packaging material, microcapsules being added to its paper stock.

EP 764 081 teaches a thermal barrier between two bases at a distance from one another, the chambers situated in between them being filled with latent heat storage material, which may have been microencapsulated.

JP-A-2001 097459 teaches the coating of a polyester fiber web with microencapsulated latent heat storage materials. The web obtained is subsequently laminated with an air cushion layer and a bag for drugs or foodstuffs is formed therefrom. There is also a reference to untreated paper whose sizing agent comprises microencapsulated latent heat storage material.

Attempts to integrate latent heat storage materials into packs are described in WO-A-97/23968 and GB-A-2336899. WO-A-97/23968 teaches a keep-warm container in whose base there are containers with latent heat storage material. GB-A-2336899 teaches a keep-warm device such as a plate whose base has a cavity which is filled with latent heat storage material.

Such additional cavities or heat stores, however, considerably increase the overall volume of the device. Moreover, its construction is very complex and is too inconvenient and expensive for simple disposable articles.

Finally, JP 2003 2237848 teaches a food container with a resin composition which is applied to the container's surface. The resin composition comprises microencapsulated latent heat storage material having a capsule wall based on acrylates, without further addressing specific acrylate compositions as wall material.

It was an object of the present invention to provide a paper-based packaging material, preferably a formaldehyde-free packaging material, from which the conventional packaging containers can be formed and which additionally is able to store heat from the immediate environment in order to keep cool the products stored therein.

Found accordingly has been a packaging material comprising at least one paper or cardboard support applied atop which there are at least one paper coating slip layer, if appropriate a print layer, if appropriate one or more thermoplastic layers and if appropriate one or more further layers, wherein at least one of the applied layers comprises microencapsulated latent heat storage material.

Found in particular has been a packaging material in the form of a composite comprising at least one paper or cardboard support applied atop which there are at least one paper coating slip layer, if appropriate a print layer, if appropriate one or more thermoplastic layers and if appropriate one or more further layers, wherein at least one of the applied layers comprises microencapsulated latent heat storage material and the capsule wall of the microencapsulated latent heat storage material is constructed from

| | |
|---|---|
| 10% to 100% | of one or more C₁-C₂₄-alkyl esters of |
| by weight | acrylic acid and/or methacrylic acid (monomers I), |
| 0% to 80% | of a difunctional or polyfunctional monomer |
| by weight | (monomers II) which is insoluble or sparingly |
| | soluble in water, and |
| 0% to 90% | of other monomers (monomer III), |
| by weight | |

based in each case on the total weight of the monomers.

The microcapsules comprised in accordance with the invention are particles having a capsule core consisting predominantly, to more than 95% by weight, of latent heat storage material and a polymer as capsule core. The capsule core is soluble or liquid depending on the temperature. The average particle size of the capsules (Z-average by means of light scattering) is 0.5 to 100 μm, preferably 1 to 80 μm, in particular 1 to 50 μm. The weight ratio of capsule core to capsule wall is generally from 50:50 to 95:5. Preference is given to a core/wall ratio of from 70:30 to 93:7.

Latent heat storage materials according to their definition are substances which exhibit a phase transition within the temperature range in which the transfer is to be performed. Preferably the latent heat storage materials exhibit a solid/liquid phase transition in the temperature range from −30 to 30° C., in particular from −30 to 20° C. and very preferably from −30 to 10° C., depending on the desired application. In general the latent heat storage material is an organic, preferably lipophilic, substance.

Examples of suitable substances include the following
aliphatic hydrocarbon compounds such as saturated or unsaturated C₁₀-C₄₀ hydrocarbons, which are branched or, preferably, linear, such as for example n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane and also cyclic hydrocarbons, e.g., cyclohexane, cyclooctane, cyclodecane;
aromatic hydrocarbon compounds such as benzene, naphthalene, biphenyl, o- or m-terphenyl, C₁-C₄₀ alkyl-substituted aromatic hydrocarbons such as dodecylbenzene, tetradecylbenzene, hexadecylbenzene, hexylnaphthalene or decylnaphthalene;
saturated or unsaturated C₆-C₃₀ fatty acids such as lauric, stearic, oleic or behenic acid, preferably eutectic mixtures of decanoic acid with, for example, myristic, palmitic or lauric acid;
fatty alcohols such as lauryl, stearyl, oleyl, myristyl or cetyl alcohol, mixtures such as coconut fatty alcohol, and also the alcohols known as oxo alcohols which are obtained by hydroformylating α-olefins and by further reactions;
C₆-C₃₀ fatty amines, such as decylamine, dodecylamine, tetradecylamine or hexadecylamine;
esters such as C₁-C₁₀ alkyl esters of fatty acids, such as propyl palmitate, methyl stearate or methyl palmitate, and, preferably, their eutectic mixtures, or methyl cinnamate;
natural and synthetic waxes such as montan acid waxes, montan ester waxes, carnauba wax, polyethylene wax, oxidized waxes, polyvinyl ether wax, ethylene-vinyl acetate wax or hard waxes by Fischer-Tropsch processes;
halogenated hydrocarbons such as chlorinated paraffin, bromooctadecane, bromopentadecane, bromononadecane, bromoeicosane, bromodocosane.

Also suitable are mixtures of these substances, provided the melting point is not lowered to outside the desired range or the heat of fusion of the mixture does not become too low for reasonable application.

Advantage is possessed, for example, by the use of pure n-alkanes, n-alkanes with a purity of more than 80%, or alkane mixtures of the kind which are obtained as a technical distillate and as such are commercially customary.

Additionally it may be advantageous to add compounds that are soluble in the substances that form the capsule core to those substances, in order thus to prevent the lowering of freezing point that occurs in part with the a polar substances. It is advantageous, as described in U.S. Pat. No. 5,456,852, to use compounds having a melting point higher by 20 to 120 K than the core substance itself. Suitable compounds are the aliphatic hydrocarbon compounds, fatty amides, fatty alcohols, and fatty acids mentioned above as lipophilic substances. They are used in amounts of 0.1% to 10% by weight, based on the capsule core.

The latent heat storage material chosen is in accordance with the temperature range within which heat storage is desired. For frozen goods, for example, latent heat storage materials are used whose solid/liquid phase transition is situated in the temperature range from −30 to 0° C. For the temperature stabilization of fresh products, examples being dairy products, it is preferred to choose latent heat storage material having a phase transition in the temperature range from 0 to 15° C. Preference is therefore given to a material having a transformation temperature in the range from −30 to 30° C., preferably to 20° C., in particular from −20 to 15° C. The choice of the transformation temperature may be dependent, for example, on the desired ambient temperature and on the nature of the interruption in the cooling chain. If, for example, the intention is to avoid any interruption during the cooling chain, such as during the filling of shelves at the retailer, then it is advantageous to choose a transformation temperature close to the desired storage temperature: for frozen goods, in the range from −20 to 0° C. and for normal chilled goods in the range from 0 to 15° C. If, on the other hand, the primary intention is that the chilled or fresh product should survive a short drive in the purchaser's overheated auto, then transformation temperatures of up to 20° C. are sufficient. Microencapsulated latent heat storage materials offer the advantage, moreover, of mixing different microcapsules with latent heat storage material of different temperature, in order thus to conform to an even more specific profile of requirements.

Preferred latent heat storage materials are aliphatic hydrocarbons, more preferably those listed by way of example above. Particular preference is given to aliphatic hydrocarbons having 10 to 17 carbon atoms, and mixtures thereof.

As polymer for the capsule wall it is possible in principle to use the materials known for the microcapsules for carbon papers. Thus it is possible, for example, to encapsulate the latent heat storage materials in accordance with the processes described in GB-A 870476, U.S. Pat. No. 2,800,457 and U.S. Pat. No. 3,041,289 in gelatin with other polymers.

Preferred wall materials, on account of their high aging stability, are thermoset polymers. By thermoset wall materials are meant those which, by virtue of the high degree of crosslinking, do not soften but instead undergo decomposition at high temperatures. Suitable thermoset wall materials are, for example, highly crosslinked formaldehyde resins, highly crosslinked polyureas and highly crosslinked polyurethanes, and also highly crosslinked methacrylic ester polymers.

By formaldehyde resins are meant reaction products of formaldehyde with
triazines such as melamine,
carbamides such as urea,
phenols such as phenol, m-cresol and resorcinol,
amino and amido compounds such as aniline, p-toluenesulfonamide, ethylene urea and guanidine,
   or mixtures thereof.

Formaldehyde resins preferred as capsule wall material are urea-formaldehyde resins, urea-resorcinol-formaldehyde resins, urea-melamine resins and melamine-formaldehyde resins. Also preferred are the C₁-C₄ alkyl ethers, especially methyl ethers, of these formaldehyde resins and also the mixtures with these formaldehyde resins. Particular preference is given to melamine-formaldehyde resins and/or their methyl ethers.

In the processes known from carbon papers the resins are used as prepolymers. The prepolymer is still soluble in the aqueous phase and in the course of polycondensation migrates to the interface, where it surrounds the oil droplets. Processes for microencapsulation with formaldehyde resins are general knowledge and are described for example in EP-A-562 344 and EP-A-974 394.

Capsule walls made of polyureas and polyurethanes are likewise known from carbon papers. The capsule walls are formed by reacting reactants carrying NH₂ groups and/or OH groups with di- and/or polyisocyanates. Examples of suitable isocyanates include ethylene diisocyanate, 1,4-tetramethylene diisocyanate, 1,6-hexamethylene diisocyanate and 2,4- and 2,6-tolylene diisocyanate. Mention may also be made of polyisocyanates such as derivatives with a biuret structure, polyuretonimines and isocyanurates. Suitable reactants include the following: hydrazine, guanidine and its salts, hydroxylamine, di- and polyamines, and amino alcohols. Interface polyaddition processes of this kind are known for example from U.S. Pat. No. 4,021,595, EP-A 0 392 876 and EP-A 0 535 384.

Preferred microcapsules are those whose capsule wall is a highly crosslinked methacrylic ester polymer. The degree of crosslinking is achieved here with a crosslinker fraction ≧10% by weight, based on the total polymer.

In the preferred microcapsules the wall-forming polymers are constructed from 10% to 100%, preferably 30 to 95% by weight of one or more C₁-C₂₄ alkyl esters of acrylic acid and/or methacrylic acid, as monomers 1. The polymers may additionally comprise in copolymerized form up to 80%, preferably 5% to 60%, in particular 10% to 50% by weight of a difunctional or polyfunctional monomer, as monomers II, which is insoluble or sparingly soluble in water. Besides these the polymers may comprise in copolymerized form up to 90%, preferably up to 50%, in particular up to 30% by weight of other monomers III.

Suitable monomers I are C₁-C₂₄ alkyl esters of acrylic and/or methacrylic acid. Particularly preferred monomers I are methyl, ethyl, n-propyl and n-butyl acrylate and/or the corresponding methacrylates. Preference is given to isopropyl, isobutyl, sec-butyl and tert-butyl acrylate and the corresponding methacrylates. Mention may also be made of methacrylonitrile. Generally speaking, the methacrylates are preferred.

Suitable monomers II are difunctional or polyfunctional monomers which are insoluble or sparingly soluble in water but have a good to limited solubility in the lipophilic substance. By sparing solubility is meant a solubility of less than 60 g/l at 20° C. By difunctional or polyfunctional monomers are meant compounds which have at least 2 nonconjugated ethylenic double bonds. Suitability is possessed primarily by divinyl monomers and polyvinyl monomers, which effect crosslinking of the capsule wall during the polymerization.

Preferred difunctional monomers are the diesters of diols with acrylic acid or methacrylic acid, and also the diallyl and divinyl ethers of these diols.

Preferred divinyl monomers are ethanediol diacrylate, divinylbenzene, ethylene glycol dimethacrylate, 1,3-butylene glycol dimethacrylate, methallylmethacrylamide and allyl methacrylate. Particular preference is given to propanediol, butanediol, pentanediol and hexanediol diacrylates or the corresponding methacrylates.

Preferred polyvinyl monomers are trimethylolpropane triacrylate and trimethacrylate, pentaerythritol triallyl ether and pentaerythrityl tetraacrylate.

Suitable monomers III are other monomers, preference being given to monomers IIIa such as vinyl acetate, vinyl propionate and vinyl pyridine.

Particular preference is given to the water-soluble monomers IIIb, examples being acrylonitrile, methacrylamide, acrylic acid, methacrylic acid, itaconic acid, maleic acid, maleic anhydride, N-vinylpyrrolidone, 2-hydroxyethyl acrylate and methacrylate, and acrylamido-2-methylpropanesulfonic acid. Besides these particular mention may be made of N-methylolacrylamide, N-methylolmethacrylamide, dimethylaminoethyl methacrylate and diethylaminoethyl methacrylate.

According to a further preferred embodiment, the wall-forming polymers are formed from 30% to 90% by weight of methacrylic acid, 10% to 70% by weight of an alkyl ester of (meth)acrylic acid, preferably methyl methacrylate, tert-butyl methacrylate, phenyl methacrylate and cyclohexyl methacrylate, and 0% to 40% by weight of further ethylenically unsaturated monomers. These further ethylenically unsaturated monomers may be the monomers I, II or III not mentioned hitherto for this embodiment. Since they generally have no substantial influence on the resultant microcapsules of this embodiment, their fraction is preferably <20% by weight, in particular <10% by weight. Microcapsules of this kind and their production are described in EP-A-1 251 954, expressly incorporated by reference.

The microcapsules suitable for use in accordance with the invention can be produced by a process referred to as in situ polymerization.

The preferred microcapsules and their preparation are known from EP-A-457 154, DE-A-10 139 171, DE-A-102 30 581 and EP-A-1 321 182, expressly incorporated by reference. Thus the microcapsules are produced by preparing, from the monomers, a free-radical initiator, a protective colloid and the lipophilic substance to be encapsulated, a stable oil-in-water emulsion in which they are present as the disperse phase. Subsequently the polymerization of the monomers is initiated by heating and controlled by further temperature increase, the polymers which form constituting the capsule wall which encloses the lipophilic substance.

In general the polymerization is conducted at 20 to 100° C., preferably at 40 to 80° C. The dispersion temperature and polymerization temperature should of course be situated above the melting temperature of the lipophilic substances.

When the final temperature has been reached the polymerization is appropriately continued for a time, for instance, of up to 2 hours in order to lower residual monomer contents. Following the actual polymerization reaction, at a conversion of 90% to 99% by weight, it is generally advantageous substantially to free the aqueous microcapsule dispersions from odorous substances, such as residual monomers and other volatile organic constituents. This can be done in conventional manner physically, by distillative removal (in particular by means of steam distillation) or by stripping with an inert gas. It may also take place chemically, as described in WO 9924525, advantageously by means of redox-initiated polymerization, as described in DE-A-4 435 423, DE-A-4419518 and DE-A-4435422.

In this way it is possible to produce microcapsules having an average particle size in the range from 0.5 to 100 μm, the particle size being adjustable in conventional manner by way of the shearing force, the stirring speed, the protective colloid, and its concentration.

Preferred protective colloids are water-soluble polymers, since they lower the surface tension of the water from 73 mN/m to a maximum of 45 to 70 mN/m and hence ensure that impervious capsule walls are formed and that the microcapsules having preferred particle sizes of between 1 and 30 μm, preferably 3 and 12 μm, are formed.

In general the microcapsules are produced in the presence of at least one organic protective colloid, which may be either anionic or neutral. It is also possible to use anionic and nonionic protective colloids together. Preference is given to using inorganic protective colloids, in a mixture if appropriate with organic protective colloids, or nonionic protective colloids.

Organic neutral protective colloids are cellulose derivatives such as hydroxyethylcellulose, methylhydroxyethylcellulose, methylcellulose and carboxymethylcellulose, polyvinylpyrrolidone, vinylpyrrolidone copolymers, gelatin, gum Arabic, xanthan, sodium alginate, casein, polyethylene glycols, preferably polyvinyl alcohol, and partially hydrolyzed polyvinyl acetates, and also methylhydroxypropylcellulose.

Suitable anionic protective colloids include polymethacrylic acid, the copolymers of sulfoethyl acrylate and sulfoethyl methacrylate, sulfopropyl acrylate and sulfopropyl methacrylate, of N-(sulfoethyl)maleimide, of 2-acrylamido-2-alkylsulfonic acids, styrenesulfonic acid, and of vinylsulfonic acid.

Preferred anionic protective colloids are naphthalenesulfonic acid and naphthalene-sulfonic acid-formaldehyde condensates and also, in particular, polyacrylic acids and phenolsulfonic acid-formaldehyde condensates.

The anionic and nonionic protective colloids are generally used in amounts of 0.1 to 10% by weight, based on the water phase of the emulsion.

Preference is given to inorganic protective colloids, known as Pickering systems, which permit stabilization by very fine solid particles and are insoluble in water but dispersible, or insoluble and not dispersible in water, but can be wetted by the lipophilic substance.

The mode of action and its use is described in EP-A-1 029 018 and also EP-A-1 321 182, whose content is expressly incorporated by reference.

A Pickering system may be composed of the solid particles alone or, in addition, of auxiliaries which improve the dispersibility of the particles in water or the wettability of the particles by the lipophilic phase.

The inorganic solid particles can be metal salts, such as salts, oxides and hydroxides of calcium, magnesium, iron, zinc, nickel, titanium, aluminum, silicon, barium and manganese. Mention may be made of magnesium hydroxide, magnesium carbonate, magnesium oxide, calcium oxalate, calcium carbonate, barium carbonate, barium sulfate, titanium dioxide, aluminum oxide, aluminum hydroxide and zinc sulfide. Silicates, bentonite, hydroxyapatite and hydrotalcites may likewise be mentioned. Particular preference is given to highly disperse silicas, magnesium pyrophosphate and tricalcium phosphate.

The Pickering systems can either be added first to the water phase or added to the stirred oil-in-water emulsion. Many fine, solid particles are prepared by precipitation, as described in EP-A-1 029 018, and also EP-A-1 321 182.

The highly disperse silicas can be dispersed as fine, solid particles in water. An alternative option is to use what are known as colloidal dispersions of silica in water. The colloidal dispersions are alkaline, aqueous mixtures of silica. In the alkaline pH range the particles are swollen and are stable in water. For the use of these dispersions as a Pickering system it is advantageous for the pH of the oil-in-water emulsion to be adjusted with an acid to a pH of 2 to 7.

The inorganic protective colloids are generally used in amount of 0.5 to 15% by weight, based on the water phase.

In general the organic neutral protective colloids are used in amounts of 0.1 to 15%, preferably 0.5% to 10%, by weight, based on the water phase.

Preferably the dispersing conditions for preparing the stable oil-in-water emulsion are chosen in a conventional manner such that the oil droplets have the size of the desired microcapsules.

On spray drying, the microcapsule dispersions obtained by the polymerization produce a capsule powder having good free-flow properties. The microcapsule dispersion can be spray-dried in conventional function. In general the procedure is such that the entry temperature of the hot air flow is in the range from 100 to 200° C., preferably 120 to 160° C., and the exit temperature of the hot air flow is in the range from 30 to 90° C., preferably 60 to 80° C. The spraying of the aqueous polymer dispersion in the hot air flow can take place for example by means of single-fluid or multi-fluid nozzles or by way of a rotating disc. The polymer powder is normally deposited using cyclones or filter separators. The sprayed aqueous polymer dispersion and the hot air flow are preferably guided in parallel.

At the spray drying stage addition is made, if appropriate, of spraying assistants, in order to facilitate spray drying, or to set particular powder properties, e.g., low dust, free-flow or improved redispersion properties. A multiplicity of spraying assistants are familiar to the skilled worker. Examples thereof are found in DE-A 19629525, DE-A 19629526, DE-A 2214410, DE-A 2445813, EP-A 407889 or EP-A 784449. Examples of advantageous spraying assistants include water-soluble polymers of the polyvinyl alcohol type or partly hydrolyzed polyvinyl acetates, cellulose derivatives such as hydroxyethylcellulose, carboxymethylcellulose, methylcellulose, methylhydroxyethyl-cellulose and methylhydroxypropylcellulose, polyvinylpyrrolidone, vinylpyrrolidone copolymers, gelatin, preferably polyvinyl alcohol and partially hydrolyzed polyvinyl acetates, and also methylhydroxypropylcellulose.

The packaging material of the invention is constructed from the paper or cardboard support and the paper coating slip layer. In general, however, it comprises the support and two, three or more layers.

The packaging material of the invention comprises in total 5 to 300 g/m² (applied weight as dry weight), preferably 15 to 200 g/m² and more preferably 30 to 150 g/m² of microencapsulated latent heat storage material.

The packaging materials of the invention, particularly those for foodstuffs, have a thickness of 0.01 to 20 mm, preferably 0.1 to 10 mm, in particular 0.5 to 2 mm.

The basic construction of a packaging material for foodstuffs may be composed, from outside to inside, of a thermoplastic layer, preferably low-pressure polyethylene, a print layer, a paper coating slip layer, a support layer made of paper, and a thermoplastic layer. Between thermoplastic layer and the paper support there are, if appropriate, one or more additional layers comprised, in order to obtain particular properties: for example, as a gas barrier, a polyamide layer or aluminum layer, generally in conjunction with a further thermoplastic layer facing the paper. Exemplary layer constructions may include the following:

thermoplastic/print layer/paper coating slip layer/paper support/thermoplastic/gas barrier (aluminum foil)/thermoplastic/thermoplastic,
thermoplastic/print layer/paper coating slip layer/paper support/thermoplastic/thermoplastic,
print layer/thermoplastic/paper coating slip layer/paper support/thermoplastic/thermoplastic, or
thermoplastic/print layer/paper coating slip layer/paper support/thermoplastic/aluminum foil/polyester (PET).

The production of a packaging material of this kind is common knowledge to the skilled worker and is described for example in EP-A-1 232 856, hereby expressly incorporated by reference.

The packaging material of the invention preferably comprises a paper or, preferably, cardboard support applied atop which there are at least one paper coating slip layer and a print layer, if appropriate one or more thermoplastic layers, and if appropriate one or more further layers. Likewise preferred is a packaging material in which at least one paper coating slip layer and one or more thermoplastic layers, a print layer if appropriate, and one or more further layers if appropriate or applied to the support. A particularly preferred packaging material is one whose support has had applied to it at least one paper coating slip layer and one print layer, one or more thermoplastic layers, and, if appropriate, one or more further layers.

The paper support has a basis weight of >40 g/m². Preferably it has a basis weight of 150 to 600 g/m², and so, in German terminology, is embraced by the term corresponding to cardboard. A distinction is made between cardboard composed of bonded paper layers and cardboard produced as a single layer from cellulose fibers, known as cellulose cardboard. Particular preference is given to a paper support having a basis weight in the range from 150 to 250 g/m².

The paper support is composed of uncoated paper or card, which has been pretreated in the usual fashion and is also referred to for the purposes of this specification as untreated paper or card, respectively. The production of untreated paper and card is common knowledge and is usually accomplished in an operation in which, preferably, sizing agents and further auxiliaries are added to an aqueous slurry of cellulose fibers and the paper pulp is drained on a wire, forming sheets. Customary process chemicals for papermaking are stock sizing agents, retention agents, strengthening agents such as epichlorohydrin-crosslinked polyamidoamines, polyvinylamines of an average molecular weight or starch, fixing agents, biocides, and dyes.

For producing paper or card, preferably sized paper or sized card, all of the cellulose fibers commonly used in the papermaking industry can be employed, examples being fibers of mechanical pulp and all annual plants. By mechanical pulp is meant, for example, groundwood, thermomechanical pulp (TMP), chemothermomechanical pulp (CTMP), pressure groundwood, semichemical pulp, high-yield pulp, refiner mechanical pulp (RMP), and wastepaper. Also suitable are chemical pulps, which can be used in bleached or unbleached form. Examples of such are sulfate pulps, sulfite pulps and soda pulps. It is preferred to use unbleached chemical pulps, which are also referred to as unbleached kraft pulp. The fibers can be used alone or in a mixture with one another.

In the stock sizing of paper or cardboard, sizing is carried out during the process of producing these materials, by adding a stock sizing agent to the paper stock and draining the paper stock on the wire of a paper machine, forming sheets. For the stock sizing of paper and cardboard use is made, for example, of 0.1 to 2.0, preferably 0.2 to 0.75% by weight of polymer size (i.e., polymer in 100% form), based on dry paper product. Customary stock sizes are aqueous dispersions of reactive sizes such as alkylketene dimers, C₅ to C₂₂ alkylsuccinic and/or C₅ to C₂₂ alkenylsuccinic anhydrides, chloroformic esters and C₁₂ to C₃₆ alkyl isocyanates, combinations of resin size and alum, combinations of reaction products of resin size with carboxylic anhydrides and alum, and polymer dispersions with a sizing action. Instead of or else in combination with alum it is possible to use other aluminum compounds such as polyaluminum chlorides or the polyaluminum compounds known from EP-B-1 091 043. The polymer sizes may of course also be used as a surface size, by applying them to the surface of the paper using, for example, a sizing press, or by spraying them onto the surface of the paper.

The paper pulp is drained in the presence of a retention agent or aid. Besides anionic retention aids or nonionic retention aids such as polyacrylamides, cationic polymers are used preferably as retention aids and draining aids. As cationic retention aids it is possible to use all of the products available commercially for that purpose.

Cardboard is normally produced by draining a slurry of cellulose fibers. Preference is given to using kraft pulp. Of particular interest, furthermore, is the use of TMP and CTMP. For the production of the paper and cardboard products for use in accordance with the invention it is possible to use other auxiliaries that are normally suitable, as well, examples being fixing agents, dyes, bacteriocides and dry and/or wet strength agents for paper.

The microcapsules used in accordance with the invention may form part of the layers applied, selected from the paper coating slip layer, the print layer and/or polyethylene layer, or may be applied as a self-standing microcapsule layer. According to one preferred version, as well as one or more of these layers, the paper or cardboard support also comprises microencapsulated latent heat storage material. In that case the microcapsules can be mixed into the pulp, the suspension of pulp in the head box, or can be added to the surface size or stock sizing agent.

According to one preferred embodiment the microencapsulated latent heat storage material is comprised in the paper coating slip layer. There are one or more coating layers (e.g., undercoat, middle coat and topcoat), each of which may comprise microcapsules.

Paper coating slips are common knowledge. They are generally composed of
a) pigment and/or filler,
b) binder and, if appropriate, cobinder,
c) a thickener if appropriate,
d) a fluorescent or phosphorescent dye if appropriate, in particular as an optical brightener,
e) if appropriate, one or more additional additives such as curing agents, defoamers, shading dyes, wetting agents, hydrophobicizing agents, leveling agents, cationic additives, OBA (optical brightness agent) carriers (PVA and starch derivatives).

A coating slip of this kind can be modified, in one version according to the invention, by replacing some of the filler or the polymeric binder with microencapsulated latent heat storage materials. In another version according to the invention, the capsules can be added to conventional paper coating slips. One preferred composition comprises a) pigment and/or filler

| | |
|---|---|
| b) 1-40 parts by weight | of binder and, if appropriate, cobinder |
| | (reckoned together as solids) |
| c) 0-5 parts by weight | of thickener (reckoned as solids) |
| d) 0-5 parts by weight | of fluorescent or phosphorescent dye |
| | (reckoned as solids), |
| e) 0-10 parts by weight | of additional additives (reckoned as solids) |
| f) 10-500 parts by weight | of microencapsulated latent heat storage |
| | material, |

based on 100 parts by weight of the total amount of the pigments and fillers (a).

Paper coating slips of this kind are likewise a part of the present invention.

The binders and cobinders (b) are substances prepared synthetically and/or substances obtained from nature.

The synthetic binders and cobinders are preferably free-radically polymerized polymers composed in total of preferably at least 30%, more preferably at least 50%, by weight of the principal monomers listed below.

Suitable principal monomers are selected from C₁ to C₁₆ alkyl (meth)acrylates, vinylaromatics having up to 20 carbon atoms, vinyl esters of carboxylic acids having 1 to 20 carbon atoms, vinyl halides, ethylenically unsaturated nitriles, nonaromatic hydrocarbons having one or two conjugated double bonds, or mixtures of these monomers. Examples that may be mentioned include (meth)acrylic acid alkyl esters with a C₁-C₁₀ alkyl radical, such as methyl methacrylate, methyl acrylate, n-butyl acrylate, ethyl acrylate and 2-ethylhexyl acrylate.

In particular, mixtures of the (meth)acrylic acid alkyl esters are also suitable.

Examples of suitable vinyl esters of carboxylic acids having 1 to 20 carbon atoms include vinyl laurate, vinyl stearate, vinyl propionate and vinyl acetate.

Suitable vinylaromatic compounds having up to 20 carbon atoms include vinyltoluene, α-butylstyrene, 4-n-butylstyrene, 4-n-decylstyrene, and, preferably, styrene. Examples of ethylenically unsaturated nitrites are acrylonitrile and methacrylonitrile.

Vinyl halides are chlorine-, fluorine- or bromine-substituted ethylenically unsaturated compounds, preferably vinyl chloride and vinylidene chloride.

As nonaromatic hydrocarbons having one or two conjugated olefinic double bonds mention may be made of butadiene, isoprene and chloroprene and also ethylene. Preference is given here generally to C₁-C₁₆ alkyl (meth)acrylates or mixtures thereof with vinylaromatics, especially styrene, or alternatively to nonaromatic hydrocarbons having two conjugated double bonds, particularly butadiene, or mixtures thereof with vinylaromatics, particularly styrene.

As well as the principal monomers the binder may comprise further monomers, examples being hydroxyl-comprising monomers, such as hydroxyalkyl acrylates or monomers containing alkoxy groups, such as are obtainable by alkoxylating hydroxyl-comprising monomers with alkoxides, especially ethylene oxide or propylene oxide, monomers containing acid groups or anhydride groups, or salts thereof, e.g., (meth)acrylic acid, maleic acid and vinylsulfonic acid.

Besides these polymers described use is also made in minor amounts of fully or partly hydrolyzed polyvinyl alcohols having different average molar masses as synthetic binders.

Suitable natural binders and cobinders include starch (oxidized and/or enzymatically degraded corn starch, potato starch or wheat starch), casein and soy protein.

The binder can be prepared in accordance with the common-knowledge method of emulsion polymerization, conventionally in the presence of a water-soluble initiator, a protective colloid and emulsifiers at, preferably, 30 to 140° C.

Examples of suitable initiators include sodium, potassium and ammonium persulfate, tert-butyl hydroperoxides, water-soluble azo compounds, or else redox initiators, such as H₂O₂/ascorbic acid.

Examples of suitable protective colloids and emulsifiers include alkali metal salts or relatively long-chain fatty acids, alkyl sulfates, alkylsulfonates, alkylated arylsulfonates, alkylated biphenyl ether sulfonates, relatively long-chain fatty alcohols, and the correspondingly alkoxylated products of the aforementioned sulfates, sulfonates and alcohols.

Preferably the binder is composed of at least 20% by weight of the principal monomers, more preferably at least 35% and very preferably at least 50% by weight.

It has proven advantageous to combine binders differing in composition (binders and cobinders), as described in EP 14904.

Suitable thickeners c), in addition to widespread synthetic polymers based on acrylic ester and urethane, include customary organic and inorganic thickeners such as carboxymethylcellulose (CMC), hydroxyethylcellulose (HEC), alginates and phyllosilicates such as bentonite.

The pigment or filler (a) generally comprises mineral white pigments of synthetic or natural type, examples being natural calcium carbonate (chalk, limestone, marble), kaolin, talc, titanium dioxide, aluminum hydroxide, zinc oxide, satin white, barium sulfate, synthetic calcium carbonate (PCC), polymer pigments, and very finely ground silicates.

The present invention further provides a process for producing the packaging material of the invention by applying a paper slip which comprises microencapsulated latent heat storage material.

The paper coating slip can be applied by customary methods to the papers that are to be coated (cf. Ullmann's Encyclopädie der Technischen Chemie, 4th Edition, Vol. 17, p. 603 ff). The paper support can be coated by applying a formulation of the abovementioned constituents uniformly to the surface of the support by means of a doctor blade, a roller, a rod or a brush. Preferred coating apparatus comprise, among other systems, air brushes or reverse gravure rollers, or other standard commercial blade or roll application systems, and also sizing presses or curtain coaters. The application of the dispersion is normally followed by a drying operation, in heated tunnels, for example. The drying temperatures are generally above 50° C., preferably from 100 to 180° C.

Besides the application methods that are generally customary (brushing, knife coating or spraying, for example), foam application is a further possibility. The paper coating slip in this case is mechanically foamed and applied to the substrate, and the foam is dried. By foam application it is possible to raise the application rate to about 200-300 g/m², with a corresponding increase in layer thickness.

In the production operation of the packaging material, the paper support can be used already in the form of coated paper. This means that in this case the paper coating slip layer is applied at an earlier point in time and not only at the stage of the production operation of the packaging material.

According to a further preferred embodiment the microencapsulated latent heat storage material is applied in the form of a microcapsule dispersion. Such a dispersion comprises one or more binders, a thickener if appropriate, one or more additional additives if appropriate, such as defoamers, wetting agents, hydrophobicizing agents, leveling agents, cationic additives, biocides and dyes, mineral fillers if appropriate, such as CaCO₃, kaolin, talc, zirconium salts, in order to enhance the blocking characteristics, and if appropriate (in the case of foam application) foaming agents and foam stabilizers.

Suitable binders are the binders set out under the paper coating slips. Preference is likewise given to the abovementioned thickeners. Insofar as mineral fillers are added, their fraction is <20% by weight, based on the overall formulation. Application takes place as described for the paper coating.

One preferred composition comprises:

| | |
|---|---|
| 20-80 parts | preferably 30-70, more preferably 40-60 parts by |
| by weight, | weight of microencapsulated latent heat storage material, |
| 20-80 parts | preferably 30-70, more preferably 40-60 parts by |
| by weight, | weight of binders, |
| 0-5 parts | preferably 0-1 part by weight of thickeners, |
| by weight, | |
| 0-10 parts | preferably 0-2 parts by weight of additional additives, |
| by weight, | and |
| 0-20 parts | of filler. |
| by weight | |

In another preferred embodiment the microencapsulated latent heat storage material is comprised in the print layer. The printing inks comprising latent heat storage media microencapsulated in accordance with the invention may be liquid printing inks such as flexographic, gravure or screen printing inks, for example, or can be pasty printing inks, for offset or letter press printing, for example. Besides the microencapsulated latent heat storage material the printing inks comprise colorants, at least one solvent or solvent mixture, at least one polymeric binder, and, optionally, further additives. They may be printing inks which dry by absorption and/or evaporation of the solvent, inks which dry oxidatively or by other mechanisms, or else UV-curable inks. The terms “pasty printing inks” and “liquid printing inks” are known to the skilled worker. Liquid printing inks comprise solvents of comparatively low viscosity and low boiling temperature, whereas pasty printing inks comprise solvents of comparatively high viscosity and high boiling temperature. Further details relating to the classification of printing inks are disclosed for example in Römpps-Lexikon “Lacke und Druckfarben”, Thieme-Verlag, Stuttgart, 1998, p. 157 ff. (especially pages 159/160, Tables 4 and 5, and the FIGURE on page 160).

In the case of the liquid printing inks/varnishes which comprise microencapsulated latent heat storage material, the amount of the microcapsules in accordance with the invention is 5% to 80% by weight, based on the sum of all the constituents of the printing ink. Preference is given to using 20% to 75%, more preferably 30% to 75% and, for example, 55% to 70% by weight.

In the case of the pasty printing inks or varnishes which comprise microencapsulated latent heat storage media, the amount of the microcapsules in accordance with the invention is 5% to 60% by weight, based on the sum of all the constituents of the printing ink. Preference is given to using 15% to 50%, more preferably 20% to 40% by weight.

As colorants it is possible to use the dyes, and especially pigments, that are customary for printing inks. Examples are inorganic pigments such as, for example, titanium dioxide pigments or iron oxide pigments, interference pigments, carbon blacks, metal powders such as, in particular, aluminum, brass or copper powders, and also organic pigments such as azo, phthalocyanine or isoindoline pigments. It is of course also possible to use mixtures of different dyes or colorants. Soluble organic dyes can also be used. The amount of colorant is usually 5%-25% by weight, based on the sum of all constituents of the printing ink. Print varnishes normally comprise little if any colorant, but may be used as a basis for producing ink.

The purposes of solvent or solvent mixture include dissolving the binders but also setting important application properties of the printing inks, the viscosity or the drying rate, for example. The nature of the solvent is guided by the particular end use of the printing ink and is selected accordingly by the skilled worker.

Solvents or components of solvent mixtures for pasty printing inks comprise, in particular, high-boiling mineral oils or vegetable oils such as soybean oil. The boiling point is generally not less than 230° C., but may even be more than 300° C.

Solvents used for liquid printing inks such as flexo and gravure inks comprise, in particular, low-boiling solvents. The boiling point is in general not more than 140° C. Screen printing inks are formulated similarly to flexo or gravure inks, but are made somewhat more viscose, and normally comprise solvents having somewhat higher boiling points. Examples of suitable solvents or liquid printing inks comprise ethanol, 1-propanol or 2-propanol, substituted alcohols such as ethoxypropanol, for example, or esters such as ethyl acetate, isopropyl acetate, n-propyl acetate or n-butyl acetate, for example. It is of course also possible to use mixtures of different solvents. Such a mixture may, for example, be a mixture of ethanol and esters such as ethyl acetate or propyl acetate. For printing with flexographic printing plates it is generally advisable for the fraction of the esters not to exceed about 20%-25% by weight of the total solvent. As solvents for liquid printing inks it is also possible with preference to use water or predominantly aqueous solvent mixtures.

Depending on the nature of the printing ink it is usual to use 10% to 55% by weight of solvent, relative to the sum of all the constituents.

Radiation-curable printing inks, rather than the abovementioned solvents, generally comprise reactive diluents. Reactive diluents typically fulfill a dual function. On the one hand they serve to crosslink or cure the printing ink, but on the other hand they also serve, like conventional solvents, to adjust the viscosity. Examples comprise butyl acrylate, (2-ethylhexyl)acrylate, and, in particular, polyfunctional acrylates such as 1,4-butanediol di(meth)acrylate, 1,6-hexanediol di(meth)acrylate or trimethylolpropane tri(meth)acrylate.

As binders for the microcapsule-comprising printing inks of the invention it is possible in principle to use the binders that are customary for liquid printing inks and pasty printing inks. The skilled worker makes an appropriate selection in accordance with the desired application and the desired properties. Examples of suitable binders comprise polyesters, polyamides, PVC copolymers, aliphatic and aromatic ketone resins, melamine-urea resins, melamine-formaldehyde resins, maleates, rosin derivatives, casein and casein derivatives, ethylcellulose, nitrocellulose or aromatic and/or aliphatic polyurethanes. Polymers or copolymers can also be used of vinyl acetate, vinyl alcohol, acrylates, methacrylates, vinylpyrrolidone or vinyl acetals. Use may be made with particular advantage of functional-group-containing hyperbranched polymers, hyperbranched polyurethanes for example, polyureas or polyesteramides, as disclosed by WO 02/36695 and WO 02/36697. It is of course also possible to use mixtures of different polymeric binders, with the proviso that the selected binders do not in combination with one another have unwanted properties. The amount of all binders is usually 5%-20% by weight, based on the sum of all of the constituents of the printing ink.

Binders particularly preferred for liquid printing inks comprise, for example, nitrocellulose, ethylcellulose, hydroxyethylcellulose and also aliphatic and aromatic polyurethanes and polyureas, especially hyperbranched polyurethanes and polyureas, and mixtures thereof.

Binders particularly suitable for water-soluble printing inks comprising microencapsulated latent heat storage media include copolymers based on (meth)acrylic acid and/or esters thereof with styrene. Binders of this kind are available commercially in the form of solutions or dispersions for use in printing inks, under the name Zinpol® (from Worlée), for example. Further examples comprise aromatic and/or aliphatic aqueous polyurethanes, polyesters and aqueous polyamides.

Binders preferred for pasty printing inks comprise, for example, rosins or modified rosins. Examples of modified rosins comprise rosins fully or partly esterified with polyols such as glycerol or pentaerythritol, for example.

Radiation-curable printing inks comprise binders comprising crosslinkable groups, such as olefinic groups, vinyl ether groups or epoxide groups, for example.

The printing inks of the invention comprising microencapsulated latent heat storage media may further comprise one or more auxiliaries or additives. Examples of additives and auxiliaries are fillers such as calcium carbonate, aluminum oxide hydrate or aluminum silicate or magnesium silicate. Waxes enhance the abrasion resistance and serve to increase the lubricity. Examples are, in particular, polyethylene waxes, oxidized polyethylene waxes, petroleum waxes or ceresin waxes. Fatty acid amides can be used to increase the surface smoothness. Plasticizers serve to increase the elasticity of the dried film. For radiation-curable printing inks an additive used additionally is at least one photoinitiator or a photoinitiator system. In order to formulate printing inks of relatively low viscosity comprising microencapsulated latent heat storage media, such as flexo, gravure or screen printing inks, the addition of antisettling agents is usually advisable, albeit not always mandatory. The total amount of all additives and auxiliaries should normally not exceed 20% by weight, based on the sum of all the constituents of the printing ink, and is preferably 0.1-10% by weight.

The printing inks of the invention comprising microencapsulated latent heat storage material can be produced in a manner known in principle by intensively mixing and/or dispersing the constituents in customary apparatus such as dissolvers or agitator mechanisms, for example.

The present invention further provides a process for producing the packaging material of the invention, by applying a print layer comprising a printing ink which comprises microencapsulated latent heat storage material, a colorant, a solvent or solvent mixture, at least one polymeric binder, and, optionally, further additives.

According to one embodiment which is likewise preferred the microencapsulated latent heat storage media are comprised in the thermoplastic layer. Suitable thermoplastic materials, generally employed in the form of films, are LDPE (low density polyethylene), HDPE (high density polyethylene), PP (polypropylene) and PET (polyethyleneterephthalate). Preference is given to using polyethylene, especially LDPE. Suitable LDPE is described at length on pages 7 and 8 of EP-A-1 232 856, expressly incorporated by reference.

The thickness of the various thermoplastic layers of the packaging material is not essential. The thicknesses customary in the packaging industry may be chosen.

The present invention further provides a thermoplastic layer comprising microencapsulated latent heat storage material, and a process for producing a packaging material of the invention by applying a thermoplastic layer which comprises microencapsulated latent heat storage material. The skilled worker makes a distinction in this case between two different application methods. In the case of extrusion coating the thermoplastic layer is extruded onto the respective layer, with the thermoplastic being pressed together with the support, which may have already been coated, to form an assembly, under the action of heat and pressure above the melting temperature of the thermoplastic. If, on the other hand, two layers are to be “adhered” to one another, so to speak, then the term used is lamination. In this case a tie layer, likewise a thermoplastic, is extruded between the two layers that are to be joined.

The microencapsulated latent heat storage material may be a constituent both of the thermoplastic foil and of the thermoplastic film.

The packaging material of the invention exhibits very good temperature-stabilizing properties. Interruptions in the cooling chain are readily absorbed by the material, with the result being only slight temperature changes in the product. The material is therefore outstandingly suitable as a packaging material for foodstuffs.

The examples which follow are intended to illustrate the invention.

Unless indicated otherwise a microcapsule powder was used of the type obtained according to example 1 of DE 101 63 162 with subsequent spray drying. The microcapsules had an average diameter of 7.8 μm. The latent heat storage material used, and its melting point, are indicated separately in each experiment.

### EXAMPLE 1

### Production of Packaging Material by Coating Cardboard with a Microcapsule Binder Dispersion of the Invention

### Paraffin Wax Core Melting Point: 24-26° C.

A coating material was prepared from the following constituents:

| | |
|---|---|
| 60 parts | of microcapsule powder having a particle size of |
| by weight | 5-20 μm and a paraffin wax core (m.p. 24-26° C.) |
| 40 parts | (reckoned as solids) Epotal ® D 600, styrene-butadiene |
| by weight | dispersion (from BASF Aktiengesellschaft), solids |
| | content 49-51% |
| about 0.2 part | of Sterocoll ®FD, acrylate-based thickener (from BASF |
| by weight | Aktiengesellschaft). |

Sterocoll FD was adjusted with ammonia to a pH of about 9 (100 parts by weight of liquid Sterocoll FD, 150 parts by weight of water, 10 parts by weight of concentrated ammonia) and added dropwise to the dispersion of microcapsules and Epotal until the target viscosity was reached. The coating material had a solids content of 42% by weight and a viscosity of 4300 mPas (Epprecht Rheometer type SVT, spindle 4).

The coating material was applied using a wire doctor to standard commercial cardboard with a basis weight of 162 g/m², and was dried at 125° C. for 2 minutes. The application rate was 40-45 g/m², calculated as the dry weight.

### EXAMPLE 2

### Production of Packaging Material by Coating Cardboard with the Microcapsule Binder Dispersion

### Paraffin Wax Core Melting Point: 28° C.

A coating material was prepared from the following constituents:

| | |
|---|---|
| 60 parts | of microcapsule powder having a particle size of |
| by weight | 5-20 μm and a paraffin wax core (m.p. 28° C.) |
| 40 parts | (reckoned as solids) Epotal D 600, styrene-butadiene |
| by weight | dispersion, solids content 49-51% |
| 0.2 part | of Sterocoll FD, acrylate-based thickener. |
| by weight | |

Sterocoll FD was adjusted with ammonia to a pH of about 9 (100 parts by weight of liquid Sterocoll FD, 150 parts by weight of water, 10 parts by weight of concentrated ammonia) and added dropwise to the dispersion of microcapsules and Epotal until the target viscosity was reached. The coating material had a solids content of 42% by weight and a viscosity of 3200 mPas (Epprecht Rheometer type SVT, spindle 4).

The coating material was applied using a wire doctor to standard commercial cardboard with a basis weight of 162 g/m², and was dried at 125° C. for 2 minutes. The application rate was 40-45 g/m², calculated as the dry weight.

### EXAMPLE 3

### Coating of Cardboard with a Paper Coating Slip Comprising Microencapsulated Latent Heat Storage Material

A paper coating slip was prepared from the following constituents:

| | |
|---|---|
| 65 parts | of microcapsule powder having an average particle |
| by weight | size of 6.5 μm and a core of technical |
| | n-tetradecane, about 94%, m.p. 6° C. |
| 30 parts | of the pigment Hydrocarb ® 90 Slurry (calculated as |
| by weight | solids), finely divided chalk from Omya GmbH |
| 5 parts | of the pigment Amazon Plus Slurry (calculated as solids), |
| by weight | a finely divided clay from Kaolin International B.V. |
| 10 parts | of Styronal ® PR 8780 X (calculated as solids), polymer |
| by weight | dispersion based on styrene/butadiene (from BASF |
| | Aktiengesellschaft) |
| 0.2 part | of Sterocoll FD, acrylate-based thickener |
| by weight | |

The paper coating slip had a solids content of 54.8% by weight, a pH of 8.8 and a viscosity of 1374 mPas (100 rpm) according to Brookfield DV-II+, spindle 4, or 59.79 mPas (at 40000 1/s) and 85.59 mPas (at 63000 1/s) according to Rheostress 600 from Thermo-Haake.

The substrates used were a kraft paper having a basis weight of 186 g/m², an uncoated cardboard having a basis weight of 200 g/m², and aluminum-coated cardboard. The paper coating slip was applied to one side of 50 g/m² on a laboratory coating machine (application method: roll, metering method: blade). Drying took place with an IR lamp.

In the same way as for the uncoated cardboard, a specialty paper for coating, satinized, wood-free, white, bleached and fully sized, with an uncoated weight of 70-80 g/m², was coated.

### EXAMPLE 4

A paper coating slip was prepared from the following constituents:

| | |
|---|---|
| 65 parts | of microcapsule powder having an average particle size |
| by weight | of 6.2 μm and a core of n-dodecane; m.p. −10° C. |
| 30 parts | of Hydrocarb 90 Slurry (calculated as solids) |
| by weight | |
| 5 parts | of Amazon Plus Slurry (calculated as solids), |
| by weight | |
| 10 parts | of Styronal PR 8780 X (calculated as solids), |
| by weight | |
| 0.2 part | of Sterocoll FD, acrylate-based thickener |
| by weight | |

The paper coating slip had a solids content of 53.1% by weight, a pH of 8.7 and a viscosity of 1592 mPas (100 rpm) according to Brookfield DV-II+, spindle 4, or 62.73 mPas (at 40000 1/s) and 43.90 mPas (at 63000 1/s) according to Rheostress 600 from Thermo-Haake.

The substrates used were a kraft paper having a basis weight of 186 g/m², an uncoated cardboard having a basis weight of 200 g/m², and aluminum-coated cardboard. The paper coating slip was applied to one side of 50 g/m² on a laboratory coating machine (application method: roll, metering method: blade). Drying took place with an IR lamp.

### EXAMPLE 5

### Foam Coating

### Microcapsule Binder Dispersion

A coating composition was prepared from the following constituents:

| | |
|---|---|
| 100 parts | of aqueous acrylate dispersion SC 50% |
| by weight | (Acronal ® A 420 S; BASF Aktiengesellschaft) |
| 40 parts | of water |
| by weight | |
| 0.6 part | of 25% strength ammonia |
| by weight | |
| 0.5 part | of Pigmentverteiler A (pigment dispersant based on |
| by weight | ammonium polyacrylate from BASF Aktiengesellschaft) |
| 0.2 part | of Helizarin ® Blue BT |
| by weight | |
| 75 parts | of microcapsule powder (m.p. 24-26° C.) |
| by weight | |
| 1 part | of Emulphor ® FES 30 (foaming agent from BASF |
| by weight | Aktiengesellschaft) |
| 7 parts | of 35% strength ammonium stearate (foam stabilizer) |
| by weight | |
| 2 parts | of Latekoll ® D (polyacrylate-based thickener |
| by weight | from BASF Aktiengesellschaft) |

Properties of the coating composition:

| | |
|---|---|
| pH | 8.5-9.5 |
| Viscosity | 23 dPas (Haake VT02, spindle 1) |

The coating composition was foamed mechanically (foam density: 280 g/l) and applied to one side of the substrate using a slotted doctor blade (600 μm). Subsequently the coated substrate was dried at 90° C. for 1 minute and at 120° C. for 1 minute. The foam layer was subsequently compressed with a calender at room temperature, using a linear pressure of 40 kN.

### EXAMPLE 6

### Coating of Cardboard by Means of PU Foam Comprising Microencapsulated Latent Heat Storage Material

The coating composition was prepared from the following constituents:

| | |
|---|---|
| 100 parts | of Emuldur ® DS 2360 (polyurethane-based |
| by weight | polymer dispersion, BASF Aktiengesellschaft) |
| 30 parts | of water |
| by weight | |
| 60 parts | of microcapsule powder (m.p. 24-26° C.) |
| by weight | |
| 10 parts | of Siligen ® SIO (BASF Aktiengesellschaft) |
| by weight | |
| 2 parts | of Saduren ® 163 (BASF Aktiengesellschaft) |
| by weight | |
| 0.5 part | of 25% strength aqueous ammonia |
| by weight | |
| 20 parts | of talc IT 20 Star |
| by weight | |
| 20 parts | of C&S Stabsol |
| by weight | |
| 1 part | of Latekoll D |
| by weight | |

Properties of the coating composition:

| | |
|---|---|
| pH | about 9.7 |
| Viscosity | about 12 dPas (Haake VT02, spindle 1) |
| solids content: | about 55% |

The coating composition was foamed mechanically (foam density 250 g/l) and 2 cardboard specimens in each case were foam-coated, with a wet foam application of 0.5 and 1 mm. This was followed by initial drying at 90° C. for 1-2 minutes and then by crosslinking at 160° C. for 1 minute. The solids add-on is 50 or 90 g/m² respectively.

1. A packaging material in the form of a composite comprising at least one paper or cardboard support applied atop which there are at least one paper coating slip layer, if appropriate a print layer, if appropriate one or more thermoplastic layers and if appropriate one or more further layers, wherein at least one of the applied layers comprises microencapsulated latent heat storage material and the capsule wall of the microencapsulated latent heat storage material is constructed from
10% to 100% by weight of one or more C₁-C₂₄-alkyl esters of acrylic acid and/or methacrylic acid (monomers I),
0% to 80% by weight of a difunctional or polyfunctional monomer (monomers II) which is insoluble or sparingly soluble in water, and
0% to 90% by weight of other monomers (monomer III),
based in each case on the total weight of the monomers.

2. The packaging material according to claim 1, wherein the latent heat storage materials is a lipophilic substance having a solid/liquid phase transition in the temperature range from −30 to +30° C.

3. The packaging material according to claim 1, wherein the latent heat storage material is an aliphatic hydrocarbon compound.

4. The packing material according to claim 1, wherein the capsule wall of the microencapsulated latent heat storage material is constructed from
10% to 95% by weight of one or more C₁-C₂₄-alkyl esters of acrylic acid and/or methacrylic acid (monomers I),
5% to 60% by weight of a difunctional or polyfunctional monomer (monomers II) which is insoluble or sparingly soluble in water, and
0% to 50% by weight of other monomers (monomer III),
based in each case on the total weight of the monomers.

5. The packing material according to claim 1, herein the capsule wall of the microencapsulated latent heat storage material is constructed from
30% to 95% by weight of one or more C₁-C₂₄-alkyl esters of acrylic acid and/or methacrylic acid (monomers I),
10% to 50% by weight of a difunctional or polyfunctional monomer (monomers II) which is insoluble or sparingly soluble in water, and
0% to 30% by weight of other monomers (monomer III),
based in each case on the total weight of the monomers.

6. The packaging material according to claim 1, wherein 5 to 300 g/m² of microencapsulated latent heat storage material is applied.

7. The packaging material according to claim 1, wherein applied atop the support are at least one paper coating slip layer and a print layer, if appropriate one or more thermoplastic layers and if appropriate one or more further layers.

8. The packaging material according to claim 1, wherein applied atop the support are at least one paper coating slip layer and one or more thermoplastic layers, if appropriate a print layer and if appropriate one or more further layers.

9. The packaging material according to claim 1, wherein applied atop the support are at least one paper coating slip layer and a print layer, one or more thermoplastic layers and if appropriate one or more further layers.

10. The packaging material according to claim 1, wherein not only the microcapsule layer but also the paper or cardboard support comprises the microencapsulated latent heat storage material.

11. The packaging material according to claim 1, wherein the paper coating slip layer comprises the microencapsulated latent heat storage material.

12. The packaging material according to claim 1, wherein the paper coating slip comprises pigment and/or filler (a),
b) 1-40 parts by weight of binder and, if appropriate, cobinder (together reckoned as solids)
c) 0-5 parts by weight of thickener (reckoned as solids)
d) 0-5 parts by weight of fluorescent or phosphorescent dye (reckoned as solids),
e) 0-10 parts by weight of additional additives (reckoned as solids) and
f) 10-500 parts by weight of microencapsulated latent heat storage material,
based on 100 parts by weight of the total amount of pigments and fillers (a).

13. A paper coating slip comprising pigment and/or filler
b) 1-40 parts by weight of binder and, if appropriate, cobinder (together reckoned as solids)
c) 0-5 parts by weight of thickener (reckoned as solids)
d) 0-5 parts by weight of fluorescent or phosphorescent dye (reckoned as solids),
e) 0-10 parts by weight of additional additives (reckoned as solids) and
f) 10-500 parts by weight of microencapsulated latent heat storage material,
based on 100 parts by weight of the total amount of pigments and fillers (a).

14. A process for producing a packaging material according to claim 1, which comprises applying a paper coating slip which comprises microencapsulated latent heat storage material.

15. The packaging material according to claim 1, wherein the print layer comprises the microencapsulated latent heat storage material.

16. The packaging material according to claim 15, wherein the print layer is obtained by applying a printing ink and the printing ink comprises a colorant, microencapsulated latent heat storage material, a solvent or solvent mixture, at least one polymeric binder, and, optionally, further additives.

17. A printing ink comprising a colorant, microencapsulated latent heat storage material, a solvent or solvent mixture, at least one polymeric binder, and, optionally, further additives.

18. A process for producing a packaging material according to claim 1, which comprises applying a print layer with a printing ink which comprises a colorant, microencapsulated latent heat storage material, a solvent or solvent mixture, at least one polymeric binder, and, optionally, further additives.

19. The packaging material according to claim 1, wherein the thermoplastic layer comprises the microencapsulated latent heat storage material.

20. A thermoplastic layer comprising a thermoplastic and microencapsulated latent heat storage material.

21. A process for producing a packaging material according to claim 1, which comprises applying a thermoplastic layer which comprises microencapsulated latent heat storage material.

22. A process for producing a packaged foodstuff comprising packaging the foodstuff with the packaging material according to claim 1.
